(19) United States
(12) Patent Application Publication
(10) Pub. No.: US 2020/0047097 A1
(43) Pub. Date: Feb. 13, 2020

(54) HOLDING DEVICE FOR FILTER ELEMENTS OF A FILTER MODULE

(71) Applicant: EISENMANN SE, Böblingen (DE)

(72) Inventors: Uwe Knaus, Ispringen (DE); Jürgen Röckle, Magstadt (DE)

(21) Appl. No.: 16/487,923

(22) PCT Filed: Jan. 12, 2018
(86) PCT No.: PCT/EP2018/050766

§ 371 Date: Aug. 22, 2019

(30) Foreign Application Priority Data
Feb. 23, 2017 (DE) 10 2017 103 794.2

(51) Int. Cl. B01D 45/08; B05B 14/43

(52) U.S. Cl. CPC B01D 45/08; B05B 14/43

(57) ABSTRACT

A holding device for filter elements of a filter module for separating overspray from booth air of a coating installation, in particular painting installations, which booth air is laden with overspray, the filter module having a filter housing, which bounds a filter chamber, through which booth air laden with overspray can be conducted in a main flow direction, a plurality of filter elements made of a filter material permeable to the booth air being arranged in the filter chamber in such a way that a flow labyrinth is formed between the filter elements, the holding device being designed to hold one or more filter elements and to position said one or more filter elements within the filter module, the holding device extending along a longitudinal axis, which is arranged transversely to the main flow direction, the holding device having a grate structure that forms the outer contour, and the one or more filter elements being holdable by means of the grate-type outer contour and thus being positionable relative to the outer contour in a stationary manner.

### BACKGROUND OF THE INVENTION

### 1. Field of the Invention

The invention relates to a holding device for filter elements of a filter module for separating overspray from overspray-laden booth air of a coating system, in particular of painting systems, to a coating system comprising a filter module having such a holding device, and to a method for coating vehicle bodies and/or vehicle parts with such a coating system.

### 2. Description of the Prior Art

During the coating of objects, such as vehicle bodies or vehicle components in a coating booth, the coating material is atomized and conveyed in the direction of the object by means of an air flow which is directed onto the object to be coated. In this case, only a part of the coating material flow intended for the object to be coated reaches the object. Another part remains in the flow as overspray and must be removed from the air flow. In the wider sense, here and in what follows the terms overspray, overspray particles and overspray solids are understood in the sense of a disperse system, such as for example an emulsion, a suspension or a combination thereof. The overspray is taken up by the air flow and delivered to a separator so that the air may optionally be returned into the coating booth after suitable treatment. Such a coating system is described, for example, in DE 10 2013 004 082 A1.

On the industrial scale, at present wet separation is preferably used for separation of the overspray. A disadvantage of this technology is the high use of energy for circulating the large amount of water, for drying the coating booth air, and the high outlay for proper disposal of the overspray washed out from the circulated air.

As an alternative separating technology, it is possible to use dry separation. In this case, the operation is carried out with electrostatic charging of the overspray, by means of which the overspray is guided onto separating surfaces and can be disposed of therefrom. Continuous processing of the separating surfaces may prove difficult and comprise a high perturbation potential. Furthermore, a high energy outlay is required.

As a further separating technology, replaceable single-use filter elements are described in the aforementioned document. In the course of the operation, coating booth air laden with overspray flows through the single-use filter elements, which thus continuously become loaded with overspray. After a limiting load is reached, the loaded filter elements are replaced with unloaded filter elements. The processing and/or the disposal of such filter elements may, with suitable selection of the filter material, have a better energy and environmental compatibility balance than the above-outlined alternatives of wet separation or electrostatic dry separation.

In a construction of such single-use filter separation, it has proven suitable to arrange the single-use filter elements in filter modules, which are for example rod-shaped or tubular. A disadvantage of existing filter modules is that the filter modules consist entirely of one filter material, and a different filter effect thus cannot be achieved inside a filter module.

### SUMMARY OF THE INVENTION

It is an object of the present invention to improved filter modules for a coating system, which alleviate the aforementioned disadvantages and, in particular, may comprise different filter materials.

The object is achieved by a holding device of filter elements of a filter module as claimed in independent claim 1. Further configurations of the invention are specified in the corresponding dependent claims.

In the holding device according to the invention for filter elements of a filter module for separating overspray from overspray-laden booth air of a coating system, in particular of a painting system, in particular for vehicle bodies and/or vehicle parts, the filter module comprises a filter housing, which delimits a filter space through which overspray-laden booth air can be delivered in a primary flow direction, wherein a multiplicity of filter elements made of a filter material which is permeable for the booth air are arranged in the filter space in such a way that a flow labyrinth is formed between the filter elements. The holding device according to the invention is configured in order to hold one or more filter elements and position them inside the filter module. The holding device extends along a longitudinal axis which is arranged transversely to the primary flow direction.

The holding device according to the invention comprises a grid structure forming an outer contour. The one or more filter elements can be held by means of the grid-like outer contour and can thus be positioned in a fixed location relative to the outer contour.

It is thus provided according to the invention to position the filter elements which fulfill the actual filter function inside a filter space of the filter housing by means of a grid structure. This has a number of advantages: the grid structure can hold different filter materials and thus retain these at the corresponding position inside the filter space. The grid structure offers a large surface area, on which the overspray-laden booth air can come in contact with the filter material of the filter element or elements. At the same time, the grid structure may be optimized for the retaining and positioning tasks, and may for example comprise reinforcements at the corresponding locations, without the filter surface having to be substantially compromised.

In one preferred embodiment, it is provided that the outer contour is configured to be cylindrical or prismatic. The cylindrical or prismatic shape may, for example, be a right hollow cylinder or a right hollow prism, which forms as it were a grid tube. This shape offers a high stability of the holding device provided with one or more filter elements. At the same time, the holding device may, for example, be inserted in a straightforward way into corresponding recesses in the filter housing or in a suitable bracket. If the base shape of a hollow prism does not have rotational symmetry, the outer shape of the hollow prism may be used for establishing the orientation of the holding device inside the filter housing and, in particular, in relation to the flow direction in cooperation with the bracket for the holding device.

In one refinement of the invention, it is provided that the grid structure comprises a flow structure on the outside. A flow structure may thus for example be formed integrally with the grid structure, which flow structure may for example be suitable for influencing and/or guiding the air flow around the holding device and therefore also around the filter element and/or the flow between the filter elements.

As an alternative or in addition, it may be provided that the holding device comprises a holding device on the inside. The holding structure may for example be inwardly projecting webs, pegs, intermediate planes or the like. By means of such structures, a filter element may be arranged in a straightforward way at the intended position and held there. In this way, in the event of progressive loading of a filter element and the thereby increasing weight thereof, it is possible to prevent the position or location from changing. Furthermore, such structures make it possible to arrange a plurality of filter elements with a defined location and position in a holding device.

As an alternative or in addition, it may be provided that the holding device comprises a connecting structure on the end side. This allows simple coupling of two holding devices to one another, possibly even without additional connecting elements.

As an alternative or in addition, it may be provided that the holding device comprises a depot structure on the end side. A depot or reservoir fitted in such a depot structure may, for example, be filled with chemical auxiliaries and additives. The auxiliaries or additives may for example be released during the filtering process, and may for example assist curing of the overspray absorbed in the filter element.

In one refinement of the invention, it may be provided that the grid structure comprises one or more segments. If the holding device comprises a plurality of segments, for example manufacture, storage and transport may be significantly simplified. The segments may, for example, divide the holding device along a longitudinal axis of the holding device and/or transversely to this longitudinal axis.

In this context, it may be advantageous for the segments to be connected to one another assemblably and/or separably and/or mutually articulatedly. The one or more articulations may, for example, be formed by hinges, which may for example be clippable to one another.

It is particularly advantageous in this context if an articulation allows tilting of the segments along an axis which extends essentially parallel to the longitudinal axis of the holding device. If the longitudinal axis of the holding device is arranged transversely to the primary flow direction, in this way for example different filter elements with a different filter effect may in a straightforward way be arranged inside the holding device.

One refinement of the invention provides a holding device for a first and a second filter element, wherein the holding device is configured in such a way that the filter elements can be arranged successively and/or next to one another along the longitudinal axis inside the holding device. This makes it possible to hold at least two filter elements, which may for example differ in terms of filter effect, filter capacity, filter material or in another way. For example, filter elements with a different filter effect may be arranged along the longitudinal axis. As an alternative, filter elements with a different filter effect—for example for fine filtering and for coarse filtering—may be arranged transversely to the longitudinal axis. This allows, for example, a series circuit of a coarse filter and a fine filter along a primary flow axis, which may for example be arranged transversely to the longitudinal axis of the holding device.

The object according to the invention is likewise achieved by a holding device as described above, having a first and a second filter element, wherein the first filter element differs in terms of its filter effect from the second filter element. In particular, it may be provided that the first filter element comprises a different filter material, a different filter density and/or a different filter material capacity than the second filter element. This allows adaptation of the overall filter module to possible flow distributions inside the filter housing, particularly inside the filter space, and makes it possible to extend the lifetime of the overall filter module.

For example, a filter element which lies in the central region of the primary flow direction may be equipped with a higher filter capacity than a filter element which lies more in the edge region of the primary flow direction.

The object is likewise achieved by a coating system having a filter module having a holding device as described above, as well as by a method for coating vehicle bodies and/or vehicle parts with a coating system which either module having a holding device as described above.

The holding devices, configured for example as grid tubes, may be produced with the aid of injection molding technology. By the use of injection molding technology finer details can be produced in and on the grid tube. One consequence is a higher degree of configurational freedom, which makes it possible to adapt the grid tube to a corresponding filter task. As an alternative, such grid structures may also be produced by a pressing process, for example by means of a round blank. In this context, material containing cellulose may for example be used for the grid structures.

If the grid tube is subdivided into individual segments, this offers advantages for the production method, which may reduce the costs. Furthermore, different filler materials with different density may be used over the longitudinal axis of the segmented grid tube. Thus, additional adaptation to the particle distribution and to the flow conditions in the filter system along the flow axis is possible. The individual segments may be connected to one another without additional means such as adhesives, wires, etc.

The grid tube may be configured to be foldable. This may greatly simplify the filling of the grid tubes with filler material. The filler material may furthermore be incorporated more easily in layers.

The grid tubes may be configured to be unfoldable or closed. The grid tubes may be manufactured in one piece or in segments, which also makes it possible to work with smaller injection molding tools. Round or polygonal (preferably hexagonal, number of vertices≥3) grid tubes may be formed. The grid tubes may be configured symmetrically or asymmetrically (asymmetry adaptation to the flow, unique assignment of the grid tube when constructing the filter system, etc.). Detailed elements may be designed for stabilization improvement (for example relatively thick individual intermediate bars), for influencing the flow profile in the filter system (for example lugs) and the like (for example for hinges, for plug connections or bolts for security against sinking, etc.). All parts may in this case be manufactured in one tool. Depots and reservoirs may be incorporated, which may subsequently be filled with chemical auxiliaries and additives. These may then be released during the filter process, and may for example assist curing of the overspray of a paint in the filter.

The invention represents a more economical alternative to previously used grid tubes which are produced with the aid of extrusion technology.

The grid tube may also be adapted to the filter task by division into individual segments. The shape may vary between round or polygonal (preferably hexagonal), as well as symmetrical or asymmetrical. In the case of angular embodiment, rotation of the tube during transport is prevented.

Additional elements such as hinges, depots/reservoirs, plug connections, additional intermediate webs, lugs, bolts, etc. may be added. Sinking of the filler material during transport by shaking may be prevented by the extra additional elements. An increase in stability by individual elements, for example additional or thicker intermediate webs, is made possible. Flow elements, for example lugs, which generate additional turbulence and which distribute both the particles to be filtered and the possible additives better in situ, may be incorporated. Different filler materials and filler densities over the length of the overall grid tube may be made possible. The use of depots and reservoirs for chemical additives (for example curing agents, catalysts, etc.) may be advantageous for adaptation of the filter system to the filter task.

### BRIEF DESCRIPTION OF THE DRAWINGS

Exemplary embodiments of the invention will be explained in more detail below with the aid of the drawings, in which:

FIG. 1 shows, in a schematic cross-sectional view, a painting booth having a separating device for overspray, in which booth air is guided to filter modules by means of an air guiding instrument,

FIG. 2 shows, in a perspective partially cutaway view, an embodiment of a filter module not equipped with filter elements

FIG. 3 shows the filter module of FIG. 2, partially equipped with filter elements;

FIG. 4 shows a plan view of the filter module of FIG. 3;

FIG. 5 shows a side view of the filter module of FIGS. 3 and 4;

FIG. 6 shows a perspective view of a first segment of a first embodiment according to the invention of a holding device;

FIG. 7 shows a perspective view of a second segment of the first embodiment of a holding device;

FIG. 8 shows the first segment of FIG. 6 connected to the second segment of FIG. 7 to form the first embodiment of the holding device,

FIG. 9 shows a perspective view of a second embodiment according to the invention of a holding device in an opened position;

FIG. 10 shows the second embodiment of FIG. 9 in a closed position;

FIG. 11 shows the second embodiment of FIGS. 9 and 10 with an inlaid filter material in an opened position;

FIG. 12 shows the second embodiment of FIG. 11 in a closed position;

FIG. 13 shows a perspective view of a third embodiment according to the invention of a holding device in an opened position; and

FIG. 14 shows a side view of a plurality of holding devices of the third embodiment of FIG. 13.

### DESCRIPTION OF PREFERRED EXEMPLARY EMBODIMENTS

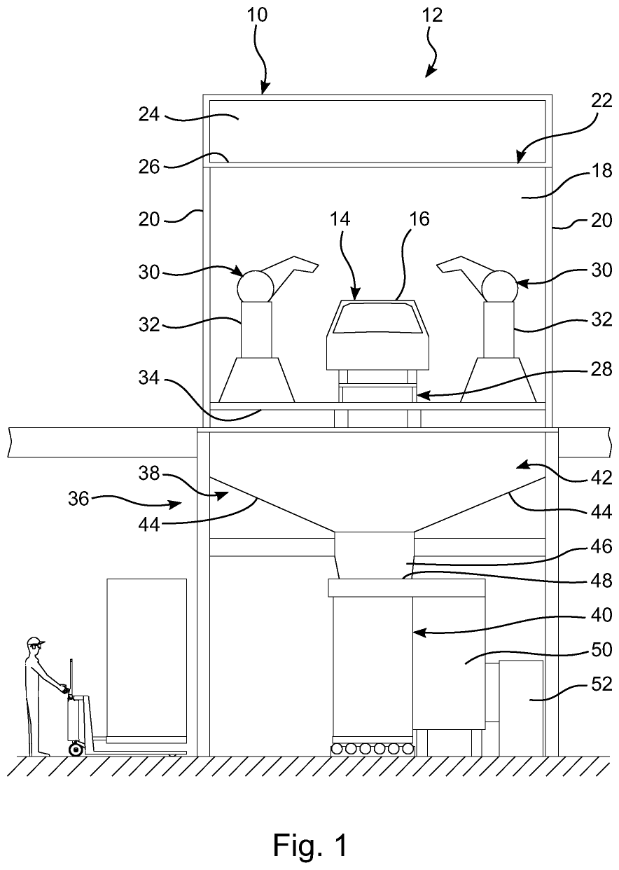

FIG. 1 shows a coating booth 10 as well as a surface treatment system, denoted overall by the reference 12, in which objects 14 are painted. Vehicle bodies 16 are shown as an example of objects 14 to be coated. Before these enter such a coating booth 10, they are for example cleaned and degreased in pretreatment stations (not shown per se).

The coating booth 10 comprises a coating or painting tunnel 18 arranged above, which is bounded by vertical side walls 20 and a horizontal booth roof 22 but is open at the end sides. The painting tunnel 18 is furthermore open in such a way that overspray-laden booth air can flow downward. The booth ceiling 22 is conventionally a lower boundary of an air delivery space 24 and configured as a filter roof 26. The vehicle bodies 16 are transported by a conveyor system 28, which is fitted in the coating tunnel 18 and is known per se, from the entry side of the coating tunnel 18 to its exit side. Inside the coating tunnel 18, there are application instruments 30 in the form of multiaxial application robots 32, such as are likewise known per se. By means of the application robots 32, the vehicle bodies 16 can be coated with the corresponding material.

Towards the bottom, the coating tunnel 18 is open through a walkable grating 34 to a system region 36 arranged underneath, in which overspray particles entrained by the booth air are separated from the booth air.

To this end, during a coating process, air flows down from the air delivery space 24 through the coating tunnel 18 to the system region 36. In this case, the air takes up paint overspray present in the coating tunnel 18 and entrains it. This overspray-laden air is guided with the aid of an air guide instrument 38 to a separating device in the form of one or more single-use filter modules 40 (referred to below as filter modules).

For this purpose, in the present exemplary embodiment, the air guide instrument 38 comprises a guide channel 42, which is formed by metal guide plates 44 that extend inward and are inclined downward from the side walls 20. The guide channel 42 opens at the bottom into a plurality of connecting channels 46 which in turn end at the bottom in a connector 48.

During a coating operation, each filter module 40 is connected fluidically and releasably to the air guide device 38. In the filter module 40, the booth air flows through one or more filter elements, on which the paint overspray is separated. This will be discussed in detail below. Overall, each filter module 40 is configured as a replaceable component.

The booth air, substantially freed of overspray particles after the filtering by the filter module 40, flows out from the filter module 40 into an intermediate channel 50, through which it enters a collecting flow channel 52. The booth air is delivered through the collecting flow channel 52 to further processing and conditioning, and is subsequently passed in a circuit (not shown separately) back into the air delivery space 24, from which it again flows into the coating tunnel 18 from above.

If the booth air is in fact not yet sufficiently freed of overspray particles by the filter modules 40 present, the filter modules 40 may be followed by further filter stages to which the booth air is delivered and in which, for example, electrostatically operating separators, such as are known per se, are also used.

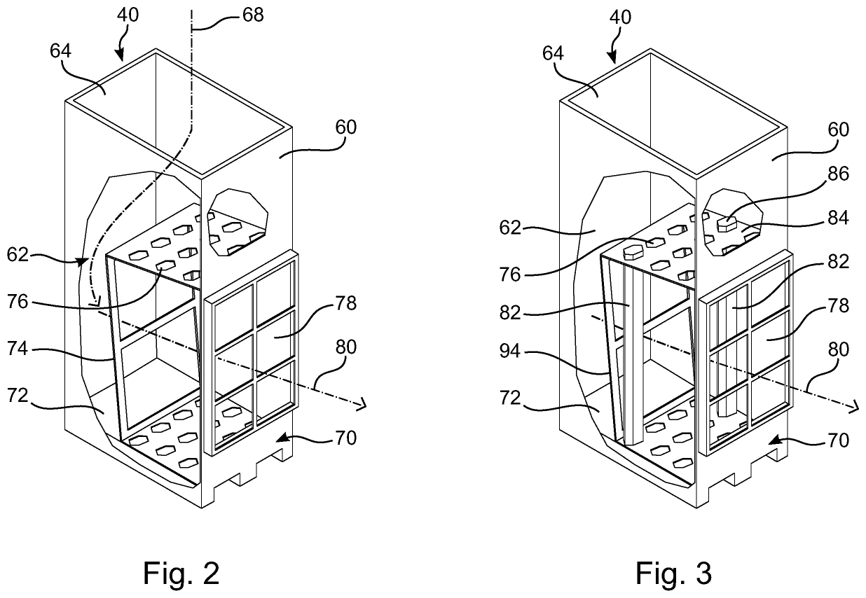

FIG. 2 shows the basic structure of a filter module 40. The filter module 40 comprises a filter module housing 60, which bounds a filter housing interior 62 that extends between a module inlet 64 and a module outlet 66 and through which the booth air flows. This gives rise to a flow profile, along which the booth air entering through the module inlet flows through the filter housing interior 62.

The module housing 60 comprises a bottom part 70, which in the present exemplary embodiment is configured in its geometry and its dimensions as a standardized carrying structure, for example according to the specification of an EUR-pallet. The arrangement of a plurality of filter modules 40 in the system region 36 of the coating booth 10 may correspondingly be carried out according to a grid which is based on the standardized bottom part 70 used.

A lower collecting region of the filter module 40 is configured fluid-tightly and in this way as a collecting trough 72 for coating material that is separated in the filter module 40 and flows away downward.

Arranged in the filter space 62, there is a retaining bracket 74 which comprises recesses 76 (not shown in FIG. 2) for retaining holding devices. The retaining bracket 74 spans a filter space 78, within which the actual filtering of the overspray-laden booth air flowing in takes place. During the filter process, the booth air flows along a primary flow direction 80 through the filter space 78, and in doing encounters the filter elements. This is represented in more detail in FIGS. 3-5 below.

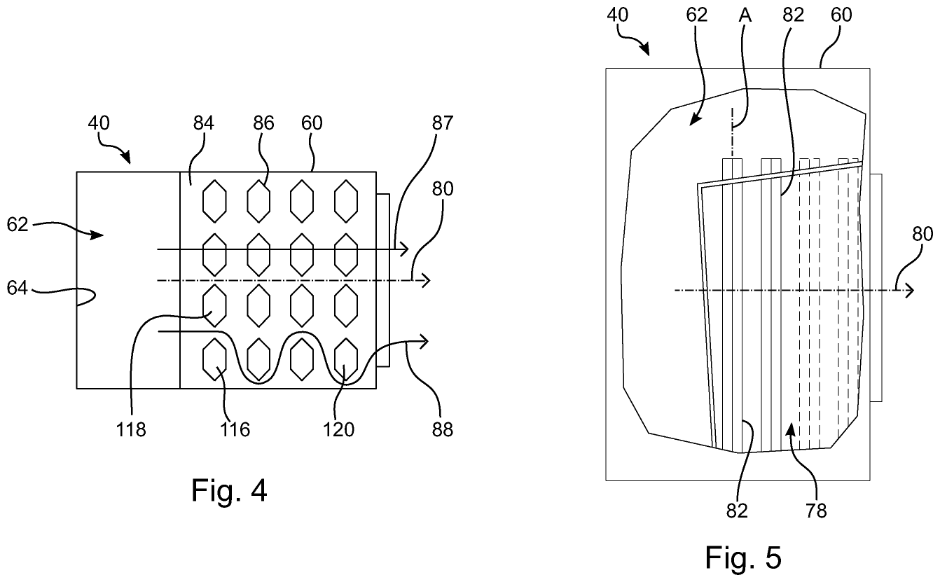

FIG. 3 shows the filter module 40 of FIG. 2 with two fitted holding devices 82. FIGS. 4 and 5 show the same situation in a schematic plan view (FIG. 4) and a schematic side view (FIG. 5).

The holding devices 82 are configured as grid tubes and carry filter elements, which can thus be positioned in the filter space 78 along the primary flow direction 80 and which the booth air can flow onto and through.

When flowing through the filter space 78, a partial flow 87 passes through the holding device 82 to a filter element located therein and flows through the latter, so long as the filter element is not fully loaded. Another partial flow 88 is deviated by the filter elements located in the holding devices. By this deviation of the air flow, heavier particles, that is to say for example overspray particles, fall out of the air flow and thus reach the filter element. The two partial flows 87, 88 are not to be understood as fixed flow paths, but rather both partial flows may be formed at one and the same filter element depending on the local loading and the direction of flow of the respective filter element, and they may also be variable over time.

The holding devices 82 may, contrary to the arrangement which can be seen well particularly in FIG. 4, be arranged offset along the primary flow direction 80. The number of holding devices 82 perpendicular to the primary flow direction 80 may increase as seen in the direction of the primary flow direction 80. This gives rise to a combination of depth filter and inertial separation. For residual overspray parts still remaining in the air, a bag filter may for example be arranged downstream.

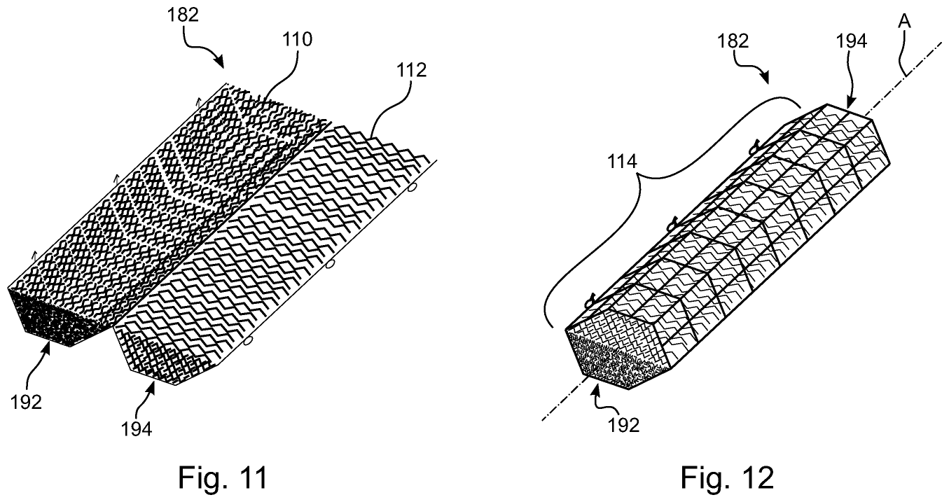

The specific structure of the filter elements will be discussed in more detail below with reference to FIGS. 11 and 12. In the embodiment of a filter module 40 as shown in FIGS. 2-5, the filter elements arranged in the holding devices 82 cannot be flowed onto from above since the holding devices 82 are covered by a cover plate 84 which provides moldings 86 for the holding devices 82. The moldings 86 correspond in their shape to the outer geometry of the holding devices 82, and thus allows accurate and simple positioning of the holding devices 82 in the flow along the primary flow direction 80.

In the embodiment shown, the moldings 86 are arranged only in the upper cover plate 84, since flow on the underside of the retentate out of the filter elements into the collecting trough 72 is intended to be possible. As an alternative, moldings may also be provided in a lower region, if for example the stability of the overall design so requires.

In the embodiment shown in FIGS. 2-5, the holding devices 82 are about 2000 mm long. This, however, only represents an exemplary embodiment. Longer or significantly shorter holding devices may, of course, also be used depending on the intended application.

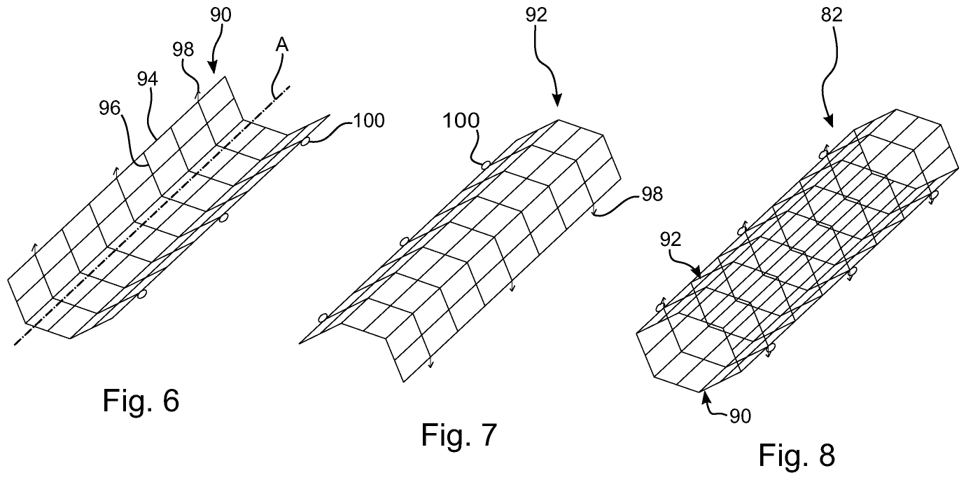

FIGS. 6-8 show a first embodiment of an embodiment according to the invention of a holding device 82. A first segment 90 is shown in FIG. 6, and a second segment 92 is shown in FIG. 7. FIG. 8 shows the two segments 90, 92 assembled to form a holding device 82. In the embodiment represented in FIGS. 6-8, the two segments 90, 92 are identical. This significantly facilitates production, storage and assembly. It is, however, also possible to produce two differently shaped segments and assemble them to form a holding device 82.

The segments 90, 92 extend along a longitudinal axis A which—as shown in FIG. 5—may be arranged transversely to the primary flow axis 80. The segments 90, 92 comprise a grid structure, forming the outer contour, with longitudinal struts 94 arranged parallel to the longitudinal axis and transverse struts 96 arranged transversely to the longitudinal axis. The grid structure is produced in terms of manufacturing technology by means of an injection-molding technique. As an alternative, as already explained above, such grid structures may also be produced by a pressing process, for example by using a round blank. If material containing cellulose is used as the material for the grid structures, advantages are for example obtained in the disposal of the holding devices together with the filter elements.

The outer geometry of the holding devices 82 may, for example, be configured to be hollow-cylindrical or hollow-prismatic. If the prismatic outer geometry is configured in such a way that it has no rotational symmetry with respect to the longitudinal axis A, the holding device 82 can only be fitted in one orientation with respect to the primary flow axis. This makes it possible to adapt the filter element filling of the holding device 82 to the flow direction to be expected, and in particular to optimize it in this respect. It is furthermore possible to configure the outer geometry of the holding devices 82 differently for different positions of the holding device 82 inside the filter space 78. Thus, on the one hand, a particularly simple assignment of the holding devices 82 with the filter elements may be achieved when constructing a filter module 40. On the other hand, the outer geometry of such a holding device 82 may take into account the different flow conditions inside the filter space 78.

Besides the pure outer geometry, structures which influence the flow, for example lugs or flow guiding structures, may also be provided, which may lead to an improvement of the flow onto the holding devices.

The grid structure may, for example, have variable material thicknesses of the longitudinal struts 94 or the transverse struts 96. For example, these may be adapted to the forces to be expected because of the intrinsic weight of the filter elements after full loading, and thus ensure a particularly good stability of the holding devices 82.

It is furthermore possible, besides the pure grid structure, to fit additional structures. The additional structures may, for example, be configured in order to permit fastening of a segment 90 to another segment 92. In this context, the segments 90, 92 comprise hook structures 98, which cooperate with eyelet structures 100. This is represented in FIG. 8: the hook structures 98 engage in the eyelet structures 100 and retain the two segments 90, 92 together.

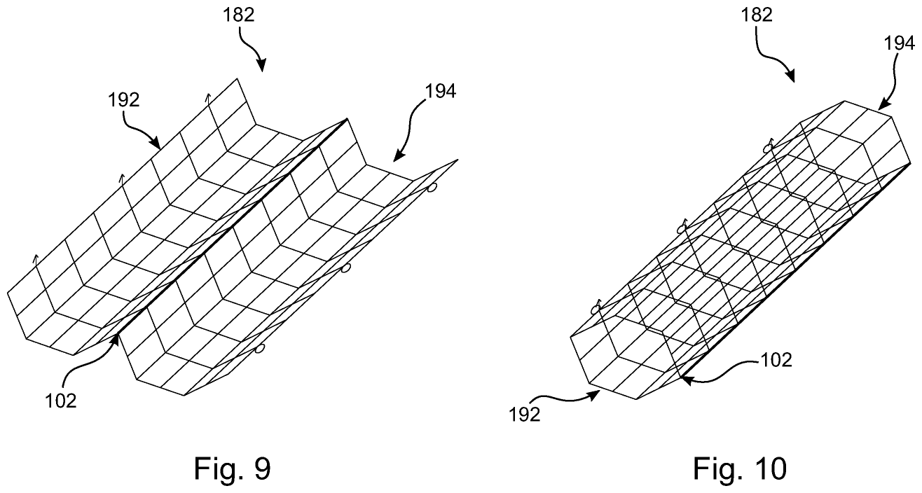

Besides the aforementioned retaining structures 98, 100, it is also possible, as is represented in FIGS. 9 and 10 in a second alternative embodiment of a holding device 182, to provide solid hinges, for example the film hinge 102. This allows particularly simple mobility of the individual subsegments 192, 194 and particularly accurate fixing of the subsegments 192, 194 to one another.

FIGS. 11 and 12 show the embodiment of a holding device 182 of FIGS. 9 and 10 with inlaid filter elements 110, 112. The filter elements 110, 112 are configured as nonwoven filters and differ in their fabric structure, particularly in their filter effect and capacity. While the first filter element 110 of a first filter type has a higher filter material density, the second filter element 112 has a lower filter material density. In conjunction with a rotational asymmetry of the assembled holding device 182 with respect to the longitudinal axis A, a simply assemblable holding device 82′ for filter elements 110, 112 is thus obtained, which is for example installable uniquely in a retaining bracket 74 in respect of its orientation with respect to the primary flow direction 80. With the inlaid filter elements 110, 112, the holding device 182 forms a filter element combination 114.

The filter element combination 114 offers the possibility of, for example, taking into account different flow conditions inside the filter space 78. Thus, a filter element combination 114 at a peripheral position 116 (see FIG. 4) is likely to experience a different incoming flow on its side lying toward the center of the flow than on its peripherally lying side. At the same time, for a filter element combination 114, the incoming flow at a central position—for example at position 118—is significantly more symmetrical. At the same time, the flow conditions and the loading of the air flow again differ significantly at a position lying downstream—for instance position 120—from a position lying upstream—for instance position 116. These effects may be counteracted by the selection of different filter materials for different filter elements 110, 112 inside a filter element combination 114.

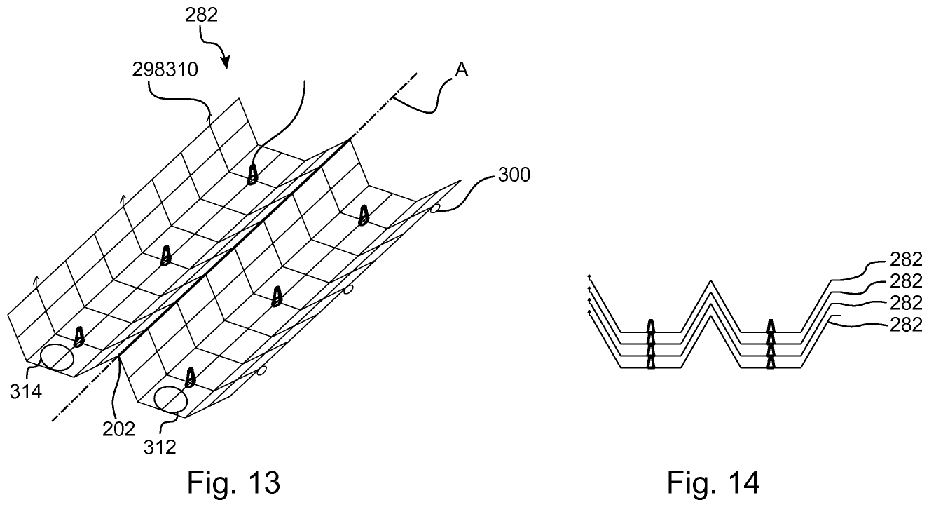

FIGS. 13 and 14 show a third embodiment of a holding device 282. Features which are the same or are comparable to features of the first or the second embodiment of the holding devices 82, 182 are provided with references to which 100 or 200 has respectively been added.

The two segments 292, 294 are, as in the second embodiment, connected tiltably to one another with a film hinge 202 parallel to a longitudinal axis A, and can be latched fixed in rotation by means of hook and eyelet structures 298, 300.

Conical pins 310—pointing inward in a closed state—are fitted on the segments 292, 294. The pins 310 are configured in such a way that a filter element 110, 112 located in the holding device is penetrated at least partially by the pins 310 and is thus fixed in its position inside the holding device 282. This contributes, in particular, to an improved stability of the filter element combination during increasing loading of a filter element.

The holding device 282 comprises depot structures 312, 314 at one end. The depot structures may, for example, be filled with an active agent, for example a curing agent or a catalyst. The depot structures 312, 314 are arranged on the holding device 282 in such a way that, in the case of a vertical orientation of the holding device 282, the depot structures 312, 314 protrude into the collecting trough 72. In this way, in the event of contact of the retentate being collected in the collecting trough 72 with the active agent contained in the depot structures, a corresponding reaction, for example curing of the retentate, is initiated or accelerated.

FIG. 14 shows a side view of a plurality of holding devices 282 stacked on one another. In this case, the pins 310 fulfil a different function. The pins 310 engage at least partially in recesses which are located on the outer side of the pins 310. In this way, a high packing density is obtained for a multiplicity of holding device for transport and storage purposes, and the holding devices can be transported securely against slipping and without tilting.

What is claimed is:

1. A holding device for filter elements of a filter module for separating overspray from overspray-laden booth air of a coating system, wherein the filter module comprises a filter housing, which delimits a filter space through which overspray-laden booth air can be delivered in a primary flow direction, and wherein a multiplicity of filter elements made of a filter material which is permeable for the booth air are arranged in the filter space in such a way that a flow labyrinth is formed between the filter elements, the holding device comprising:
a grid tube, wherein the holding device is configured in order to hold one or more filter elements and to position them inside the filter module and is configured to extend along a longitudinal axis which is arranged transversely to the primary flow direction, and
further wherein the one or more filter elements can be held by means of the grid tube and can thus be positioned in a fixed location relative to the outer contour.

2. The holding device as claimed in claim 1, wherein the outer contour is configured to be cylindrical or prismatic.

3. The holding device as claimed in claim 2, wherein, in the case of a prismatic configuration of the outer contour, at least two side edges are of unequal length.

4. The holding device as claimed in claim 1, wherein the grid structure comprises a flow structure on the outside and/or a retaining structure on the inside and/or a connecting structure and/or a depot structure on the end side.

5. The holding device as claimed in claim 4, wherein the depot structure, in the case of a vertical orientation of the holding device, is arranged in a lower region of the holding device.

6. The holding device as claimed in claim 1, wherein the grid structure comprises one or more segments.

7. The holding device as claimed in claim 6, wherein the segments are connected to one another assemblably and/or separably and/or mutually articulatedly.

8. The holding device as claimed in claim 7, wherein articulations allow tilting of the segments along an axis which extends essentially parallel to the longitudinal axis of the holding device.

9. The holding device as claimed in claim 1, for a first and a second filter element, wherein the holding device is configured in such a way that the filter elements can be arranged successively and/or next to one another along the longitudinal axis inside the holding device.

10. The holding device as claimed in claim 9, wherein, in the case of arrangement of the filter elements next to one another, a first filter material is configured for fine filtering and a second filter material is configured for coarse filtering.

11. The holding device as claimed in claim 9, having a first and a second filter element, wherein the first filter element differs in terms of its filter effect from the second filter element.

12. The holding device as claimed in claim 11, wherein the first filter element comprises a different filter material, a different filter capacity and/or a different filter material density than the second filter element.

13. A coating system comprising a filter module having a holding device as claimed claim 1.

14. A method for coating vehicle bodies and/or vehicle parts with a coating system which comprises a filter module having a holding device as claimed in claim 1.
